(19) United States
(12) Patent Application Publication
(10) Pub. No.: US 2012/0058299 A1
(43) Pub. Date: Mar. 8, 2012

(54) Composite Sandwich Panel

(75) Inventor: Bo Serwin, Hojbjerg (DK)

(73) Assignee: Connovate ApS

(21) Appl. No.: 13/256,937

(22) PCT Filed: Mar. 17, 2010
(86) PCT No.: PCT/DK2010/050062

§ 371 Date: Oct. 19, 2011

(30) Foreign Application Priority Data
Mar. 17, 2009 (DK) PA 2009 00373

(51) Int. Cl. B32B 3/10; B32B 13/02; B32B 13/12; B32B 37/12; B32B 5/18; B32B 5/00; B32B 3/30; B32B 13/04; B32B 3/26

(52) U.S. Cl. 428/131; 428/332; 428/312.6; 428/319.1; 428/293.4; 428/297.7; 428/300.7; 442/226; 428/220; 428/161; 428/172; 428/189; 156/330; 156/244.11

(57) ABSTRACT

Constructional panel having a front side suitable to be exposed to outside weather conditions, comprising a front side element, a rear side element and an insulating material arranged between said front and rear side elements, where the front side element is made from a high strength concrete, and where the insulating material is adhered to the rear side of said front and rear side elements.

### FIELD OF THE INVENTION

The present invention is directed to a constructional panel, having a front side suitable to be exposed to outside weather conditions as well as a method for manufacturing such a constructional panel.

### BACKGROUND OF THE INVENTION

In the art it has been known to use prefabricated concrete panels for many years. As the cost of transportation and mounting of panels of this type has increased, a desire to create stronger, lighter and easier to handle panels has increased. Particularly panels having insulating properties in combination with high strength are desirable. In the art a number of suggestions for such panels, see for example US 2008 276559, are presented, but due to the weight of such panels in combination with a desire to reduce the installation cost and handling cost, the panel sizes are relatively small. This in turn creates higher installation cost in that often extra manpower or heavier equipment is necessary in order to handle the panels.

U.S. Pat. No. 5,351,454 disclose a sandwich panel comprising a front and a rear concrete panel, having an insulating layer interposed. The object of the invention is to provide a construction panel which is weather resistant, heat and sound insulating and which does not reflect electromagnetic waves. Therefore non metallic fibre reinforcement is used, and the front and rear concrete panels are connected by plastic members or other non metallic connectors. The material thicknesses are within traditional ranges, and as such an almost traditional concrete sandwich panels is provided.

Furthermore, traditional concrete will especially when placed in environments close to the sea or in frost prone regions be exposed to environmental influences which can be very detrimental for the concrete. This is due to the fact that traditional concrete will have a relatively open pore structure, which will absorb water, which when freezing will expand and in some instances make the concrete surface flake off. Also in maritime environments, the salt will cause the chloride to penetrate into the concrete such that the protective environments created by the high alkali content of the concrete around the reinforcement will be neutralised. The neutralisation may cause corrosion to incur in the reinforcement which again can have a destructive influence on the concrete. Furthermore, similar mechanisms may arise where CO₂ enters the concrete, which will cause carbonisation and again neutralise the alkali environment in the concrete structure.

These mechanisms in many cases shorten the life expectancy of concrete structures. In other instances, it is necessary to surface-treat the concrete structures, for example by applying external claddings or paint at regular intervals.

DE 2939877 disclose a cement-based standard concrete sandwich panel, having extreme thin inner and outer concrete layers, and a very thin insulation layer arranged between the two concrete layers. As the insulation layer is very thin and relatively stiff, the overall rigidity of the panel may be sufficient for some applications. However for larger constructions where increased demands on insulation properties demands substantially thicker insulation layers, the construction will not be able to provide sufficient rigidity, and in particular where softer types of insulation is used, such as glass-wool or rock-wool, for example due to fire requirements, the proposed construction is not suitable. Furthermore the very thin concrete layers in combination with relatively large areas will make the concrete crack, even with the proposed fibre-reinforcement. Cracks will open the construction up to the environment, and the outer shield which the concrete facing provides is therefore lost.

A further increasingly important aspect with traditional concrete is CO2 emission created by the use of cement. A relatively heavy concrete construction requires a substantial amount of cement, which during its manufacture causes a substantial CO2 release. Furthermore transport and the building in process of traditional concrete panels requires energy, which usually stems from fossil fuels, which again will emit CO2. After end service life of the structure, it is again energy consuming to remove and reuse the concrete. Consequently although concrete has a number of material and constructional advantages as compared to other materials, it also has a substantial impact on the environment.

With heavy traditional concrete constructions insulating properties and constructions minimizing thermal bridges are at a premium. Normal concrete has poor insulating properties, and as the structural demands often demands a substantial material thickness in combination with a substantial insulating layer, integrity issues arises. For many traditional sandwich panels the concrete thickness will be in the order of 10 to 20 cm, the insulating layer for example rock-wool or glass-wool 15 to 25 cm and a further concrete layer of 10 to 15 cm. It therefore requires special designs to provide strong bonds between the front and rear concrete layers, which is not provided by the relatively weak insulation. Steel stringers or other means may here be used.

In U.S. Pat. No. 535,454 this problem is addressed by providing overlapping concrete flanges between the front and rear concrete panels. This, however, admittedly creates a thermal bridge.

### OBJECT OF THE INVENTION

Consequently, it is an object of the present invention to provide a lightweight, strong constructional panel which due to the inherent characteristics of the materials being used in constructing the panel will have a high resistency towards some of the detrimental influences which environments may have on the panels.

### DESCRIPTION OF THE INVENTION

The present invention addresses this by providing a constructional panel having a front side suitable to be exposed to outside weather conditions, comprising a front side element, a rear side element and an insulating material arranged between said front and rear side elements, where the front side element is made from a high-strength concrete, and where the insulating material is adhered to the rear side of said front and rear side elements.

The provision of a high-strength concrete front side element provides for a very strong and stiff constructional panel, and at the same time the material characteristics of the high-strength concrete provides for a very dense and compact surface such that the panel without any further treatment is able to withstand harsh environmental conditions. Furthermore, the high-strength concrete also provides the possibility of making the front side element relatively light in that the strength characteristics of the concrete is such that, as opposed to traditional concrete, a very thin material thickness may be utilised in order to achieve the strength characteristics necessary for constructional panels of this type.

In a further advantageous embodiment of the invention, the front and rear side elements are made from a high strength concrete, having a compressive strength of at least 100 MPa, preferably more than 250 MPa and most preferred more than 400 MPa and where the concrete material thickness is between 5 mm to 30 mm, more preferred 8 mm to 20 mm, and most preferred 10 mm to 15 mm.

At least within the context of this application, the expression “high-strength concrete” shall be interpreted as meaning concrete with a compressive strength of at least 100 MPa. Traditional concretes used for constructional concrete panels and the like, traditionally have a strength in the area between 25-50 MPa such that the concretes used within the scope of the present invention have at least double and more preferably four times higher compressive strength than traditional concretes. This in turn facilitates the possibility of using concrete with a material thickness between 5 mm and 30 mm. In order to provide the strength necessary at least for compression only a very thin concrete panel is necessary, and at the same time the concrete's ability to withstand environmental impacts is very high such that even with concrete thickness of 5 mm, a very high protection is provided for the construction in which a constructional panel according to the present invention is used.

In a still further advantageous embodiment of the invention, fibres are comprised in the concrete material, where the fibre content is between 1% and 10% by weight of dry material weight, more preferred 2% to 5% by weight of dry material, and where the fibres are selected among fibres made from carbon, glass, polypropylene, polyethylene, steel and in particular stainless steel, ceramics.

In some embodiments of the invention, it is advantageous to provide the constructional panel with properties against bending and some degree of tensioning. This is done by adding fibre to the concrete layers such that the bending and tension properties of the material are improved. At the same time the fibre content will add ductility to the concrete whereby the concrete panels will be more resistant against mechanical influences, which are especially prone to occur during handling of the constructional panels prior to the finished installation.

In a still further advantageous embodiment of the invention, the insulating material is a foam, and in particular a polystyrene or polyurethane foam, or an expanded material, in particular a rock/mineral wool or a glass wool, where the thickness of the insulating material between the front and rear side elements is 100 mm to 350 mm more preferred 150 mm to 275 mm, and most preferred 175 mm to 250 mm.

Due to the relatively shallow construction depth of the panels, i.e. the combination of front side element/rear side element and insulation, where the front side element typically is between 5 and 30 mm and in some embodiments, the rear side element has the same thickness, it is possible when using insulating materials for example in the shape of a foam or an expanded material to provide a relatively high insulating value with a limited wall thickness. Especially as the requirements to insulation increase, it is becoming increasingly interesting to be able to provide high insulation values without having to use thick construction elements in that the user-friendliness of a building as well as other requirements such as for example the ability of daylight to enter a building may be improved. When outer walls become too thick, apertures in the building providing room for windows, doors and the like will expose the entire thickness of the wall. This is not desirable, when the building opening is suitable for a window, in that the wall thickness to a certain degree will shade the window such that limited daylight will be able to enter through the window.

In a yet further advantageous embodiment of the invention, reinforcement is integrated in the insulating material, where said reinforcement may be arranged between the front and rear side elements and/or arranged parallel to said front side on the surface of or inside the insulating material.

In this manner, it is possible to improve the integrity of the constructional panel by stabilising the insulating material by connecting the front and rear side elements such that for example when the insulating material is foam, a slight compression is created by the reinforcement, whereby the overall stiffness of the constructional panel is increased. Also relating to shear forces in the constructional panel, the reinforcement will be able to transmit any shear forces to the concrete structure, which due to its inherent characteristics will be able to withstand a certain amount of shearing or distribute the forces to a larger area such that the force per unit is substantially diminished. The specific arrangement of the reinforcement is to be decided on depending on the circumstances in which the constructional panel is to be used. For example for a number of applications where the constructional panels are used as exterior panels on a building construction, it may be advantageous to provide reinforcement both parallel to and perpendicular to the exposed surface of the panel in order to be able to transmit and absorb the forces which the panel will be exposed to. For other panels where the main impact is from wind, reinforcement will be provided in order to avoid bending of the panels due to the force of the wind. As will be explained below with reference to the specific embodiments illustrated in the appended drawings, the reinforcement may be carried out in a number of various manners or combinations.

One type of reinforcement may be in the shape of a woven fibre textile or a bundle of fibres which textile or bundle of fibres is arranged partly parallel to a side element and across the thickness of said insulation, and where the reinforcement optionally is adhered to the front and/or rear side elements or is partly embedded in the concrete material.

An important aspect of the reinforcement is to provide good contact between the reinforcement and the front respectively rear side elements such that forces may be transmitted from one preferably concrete member to another concrete member. The connection between the reinforcement and the front respectively rear side elements may be provided either by applying an appropriate adhesive, such as for example an epoxy-based resin, to the side of the front and rear side elements which are facing the insulation, making sure that the adhesive layer has a substantial thickness such that it will be possible to embed part or all of the reinforcement material in the adhesive layer. Alternatively, the reinforcement may be installed while the concrete of the front side element is still wet such that the reinforcement is integrated into the concrete matrix. As the concrete matrix hardens, the reinforcement will be maintained in a firm grip by the concrete and in this manner provide a safe and reliable connection between the reinforcement and the front respectively rear side elements.

In a further advantageous embodiment the reinforcement is further substantially saturated by a polyester or epoxy-based resin. This may be done in order to avoid corrosion or deterioration and especially when the textile is made from material which may react with the highly alkaline environment in the concrete, it is desirable to protect the reinforcement such that the integrity of the reinforcement is maintained.

In a still further advantageous embodiment, special provisions for reinforcement are introduced, where on the side of the front side element and/or the rear side element being in contact with the insulation, concrete protrusions are arranged spanning a certain distance, and where concrete reinforcement is provided embedded in said protrusions, and where accommodating grooves for accommodating the protrusions are provided in the insulation.

The protrusions will in fact be ridges on the backside of the front side element and/or the rear side element, where the ridges will provide for an extra concrete material thickness in order to be able to embed the reinforcement. The reinforcement will typically be arranged for specific purposes in that by placing the reinforcement very close to an exterior surface of the finished constructional panel, the ability of the reinforcement to counter bending stresses which will be relayed as tension in the panel's outer layer is very high. The transferral forces from the front respectively rear side element across the insulating material may be improved by further introducing reinforcement as already suggested above such that the internal integrity of the panel is such that it is possible to transfer relatively large stresses from one side of the panel to the other side. In situations where it is known that the panel will be placed in a windy environment, it will usually be enough to provide the protrusions in the rear side element in that the front side element, which will be exposed to the weather, will absorb some of the stresses as compression and due to the transferral of stress through the insulation, the rear side plate will be exposed to tension, whereby the reinforcement embedded according to the present embodiment will be able to absorb the stresses in its reinforcement. The ridges will furthermore increase the moment of resistance. Particularly as the panels are made from high strength concrete even relatively shallow ridges has a relatively high influence on the overall strength of the panel.

The reinforcement embedded in the ridges may be any type, but especially non corrosive reinforcements such as glass fibre bundles, carbon fibres or basalt fiber reinforcement are preferred.

It is also contemplated within the present invention as expressed in a further advantageous embodiment that the panels are manufactured in standard sizes, preferably 900 mm wide, 2000 mm long and thicknesses between 120 min and 450 mm.

These standard sizes usually fit with the modular manner of construction, and as such the panels can be used as standard constructional panels in many constructions. The thickness of the panels is such as already mentioned above that in addition to providing good protection against environmental influences to which buildings normally are exposed, it also provides added insulation such that the overall construction thickness may be limited. The further advantage of having constructional panels of more or less standard size is the fact that it is possible to manufacture the panels, store the panels and then deliver the panels after they have matured sufficiently without having to manufacture and design the panels for each specific project.

In a further advantageous embodiment the panel is limited by side edges between said front side element and said rear side element, where the side edges comprises an insulating section, such that along the side edges the front side elements and rear side elements are not thermally connected.

One of the typical problems with traditional constructions is the creation of thermal bridges, i.e. sections in the construction where there is a heat conducting connection, between the inside and the outside of a panel. In order to avoid this, the constructional panels according to the present invention are provided with an insulating section separating the front side element from said rear side element by means of the insulating section. The reinforcement as already discussed above assures the integrity of the panel such that a concrete connection is not necessarily along the edges in order for the panels to exhibit the required rigidity.

In a further advantageous embodiment the groove is provided in said side edges in which groove a resilient profile is retained. The resilient profile may for example be accommodated in grooves in adjacent panels such that the resilient profile will provide a moisture barrier. It is also contemplated that resilient profiles in adjacent panels may engage and by the resilient properties of the profile which in the mounted position projects outside the side edges of adjacent panels when these are mounted at the correct distance such that the resilient profiles are lightly compressed, the resilient profiles will in this matter provide a moisture and wind barrier.

In a further advantageous embodiment a part of a frame for a door, window or the like is cast into the concrete of the front and rear side elements, spanning the insulating section, where said part of a frame is provided with means for engaging and snapping on the rest of the frame.

A number of advantages are achieved in this manner, for example by inserting the part of the frame in the mould in which the constructional panel according to the invention is manufactured a very precise positioning is achieved and at the same time a complete finishing of that side of the panel is achieved. By further more providing the part of the frame with means such that the mounting of the for example window is carried out simply by snapping the window into place a very rational construction process is assured and the probabilities of errors during erection of the building are minimized. Typically the types of frames which will be cast into the panels in this manner will be made from glass fibre reinforced composites or polymers. That is to say materials which are not heat conducting.

In a further advantageous embodiment of the invention the insulating sections along two side edges projects past the concrete panels, and that the insulating sections along two other sides are recessed relative to the concrete panels. In this manner it is possible to provide an assembly between two adjacent panels in a tongue and groove manner, where the groove is provided by the recessed insulation and the tongue is provided by the insulation projecting passed the concrete. In this manner a very good thermal connection is provided such that no thermal bridge occurs in the connection between two adjacent panels.

In a still further advantageous embodiment the upper and lower edge of the rear resp. front side elements has an enlarged concrete foot section. By providing an enlarged concrete foot section substantially along the entire edge of the panel a reinforced and stronger structure is provided along the edges of the panel. Also in addition firm sides are provided in order to provide surfaces and backup for the created wind, water and heat insulating properties of the joints between adjacent panels. The insulating section assures that there will be no thermal bridge and as such a number of advantages are achieved by providing this enlarged footing.

It should also be contemplated that the insulating section between the front respectively rear side elements is provided with fire retarding properties and/or has a class of insulation properties suitable to the use against fires. Tests has indicated that by compressing the heat insulating material, for example a rock wool during manufacture and allowing the rock wool to expand once two constructional panels are placed in a construction with the correct distance between them, the rock wool will expand to such a degree that a very efficient fire barrier is created.

The invention is also directed at a method for manufacturing constructional panels as described above, wherein a front side element is placed with its face down, insulating material is placed on top of the front side element, and the rear side element is placed on top of the insulation, where the insulation is pre-made with reinforcement, and where prior to placing the reinforcement on the front side element, an adhesive, for example an epoxy resin, is arranged on the front side element, and after having placed the insulation material, the free surface of the insulation is treated with an adhesive, for example an epoxy based resin, after which the rear side panel is placed on the insulation material.

As this method of manufacture is especially suited for factory production, the condition surrounding all the parts of the constructional panel may be controlled and maintained at optimum parameters such that the constructional panel during its manufacturing is not exposed to influences which could have a detrimental effect on the finished panel. Among the factors which can be controlled is the temperature, relative humidity, hardening times, quality of the insulation used to maintain low tolerances, freshness of concrete used, concrete placement in mould or controlled extrusion process etc.

### DESCRIPTION OF THE DRAWING

FIG. 1-5 illustrate various basic panel constructions;

FIG. 6-13 illustrate schematic details of assembling two panels;

FIG. 14-23 illustrate assembly/connection details from a detailed construction.

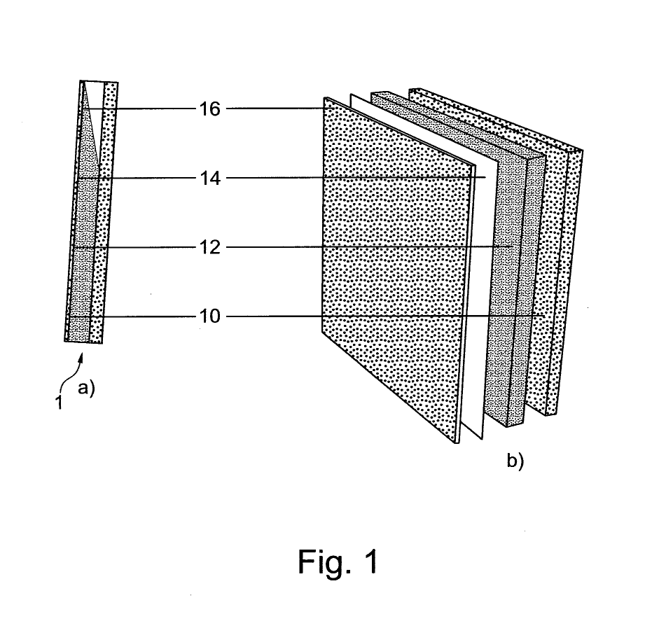

In FIG. 1-5 are illustrated various embodiments of the panel per se, i.e. the construction of the different layers making up a finished constructional panel according to the present invention.

In FIG. 1 is illustrated a first embodiment of such a construction. The constructional panel 1 in this embodiment comprises four distinctive layers as illustrated in FIG. 1b. A first layer 10 is a conventional concrete part, cast with an insulating layer 12 such that there is an intimate contact between the concrete layer 10 and the insulating layer 12. Thereafter a woven or non woven fibre cloth 14 is arranged and the front side element 16 of the panel 1 is made from a high strength concrete. The traditional concrete rear side element 10 may be used in instances where it is desirable to have a certain weight for example in connection with noise damping or in order to achieve a down-ward force which may be desirable when countering wind loads on a roof structure.

The insulating layer 12 may be for example a relatively ridged foam such as for example Neopor® whereby the overall rigidity of the panel is assured. As evident especially from the exploded view in FIG. 1b the insulating layer constitutes a substantial part of the overall thickness of the panel. It is also contemplated using cement based inorganic foams, which for a number of applications exhibit advantageous advantages which are not achievable with rock or mineral wool or polymer foam insulating products.

In practise the woven or non woven fibre reinforced material 14 will be partly embedded in the high strength concrete layer 16 during manufacture and create a good connection between the insulating layer 12 and the non woven or woven material 14. By providing an adhesive the two layers 14, 12 will create a very strong contact. A woven or non woven cloth having a density of 400 grams per square meter with a relatively open mesh has proven to be very effective. The high strength concrete layer 16 will typically be between 5 and 30 millimeter thick. In this embodiment, since the traditional concrete layer 10 will be able to transfer any loads, the high strength concrete layer 16 may be relatively thin. The concrete may be selected having a compressive strength of 100 MPa or more and preferably 250 MPa, which will provide many of the advantages inherent to high strength concrete. Some of these advantages is the dense structure of the concrete such that the ingress of water and pollutants especially carbon dioxide will be minimal whereby deterioration of the concrete layer may be avoided more or less completely.

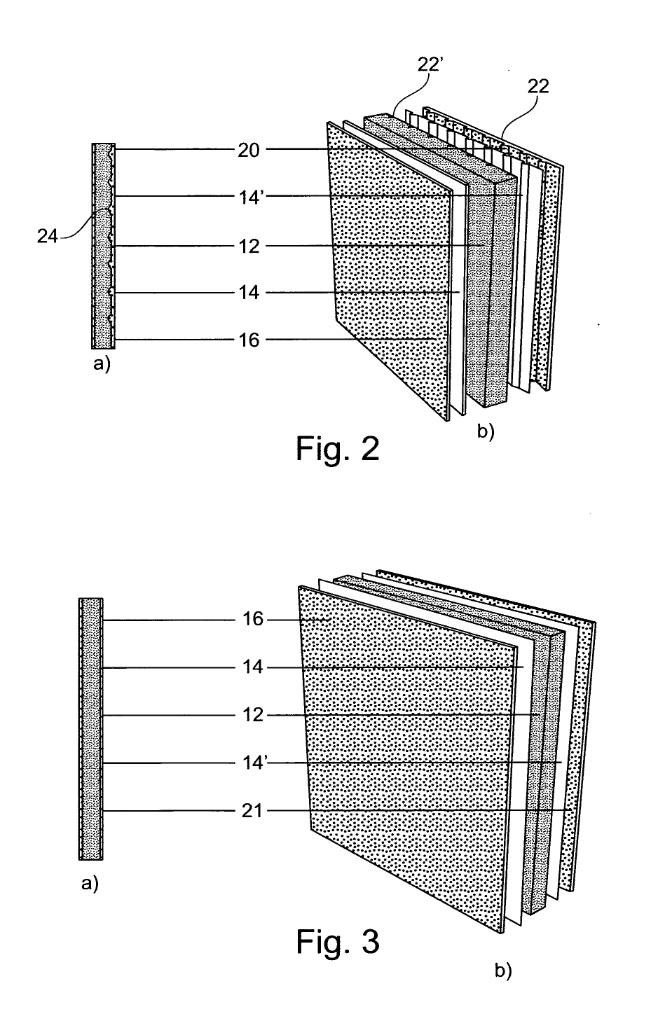

Turn into FIG. 2 another embodiment of the invention is illustrated where like features are provided with like reference numbers. Again the high strength concrete layer 16 is connected to the insulation 12 by means of a mesh 14.

The rear side element 20 is in this embodiment also a high strength concrete panel. The rear side element 20 is connected to the insulating layer 12 in the same manner as the front side element 16 is connected to the insulating layer, namely by means of a further woven or non woven cloth 14′ which in the same advantageous manner will create a very strong and rigid connection between the rear side element 20 and the insulating layer 12.

The rear side element 20 is further more provided with vertical as well as horizontal ribs 22, 24 such that the stiffness of the rear side element is greatly improved. In order to accommodate the ribs 22, 24 the insulating element is provided with recesses 22′ which will accommodate the ridges 22. The woven or non woven cloth is pliable and as such the cloth will deform to the shape of the ridges 22 and the shape of the recesses 22′. In practise the woven or non woven cloth 14′ will be applied to the concrete 22 while the concrete matrix is still wet such that an intimate bond between the concrete and the cloth 14′ is achieved. Prior to being inserted into the recesses 22′ in the insulating layer 12 the cloth will be more or less saturated with a suitable adhesive for example an epoxy based adhesive.

In a further embodiment as illustrated with reference to FIG. 3a and FIG. 3b a substantially symmetrical panel is provided where the front side and rear side elements 16, 21 are both made from relatively thin high strength concrete layers. The connection between the insulating layer 12 and the woven or non woven cloth 14, 14′ are achieved in the same manner as already explained above. These panels are especially useful due to the very light construction where it is desirable for example to create a light weight facade element which on the other hand requires very little maintenance and which is not exposed to severe loads or forces.

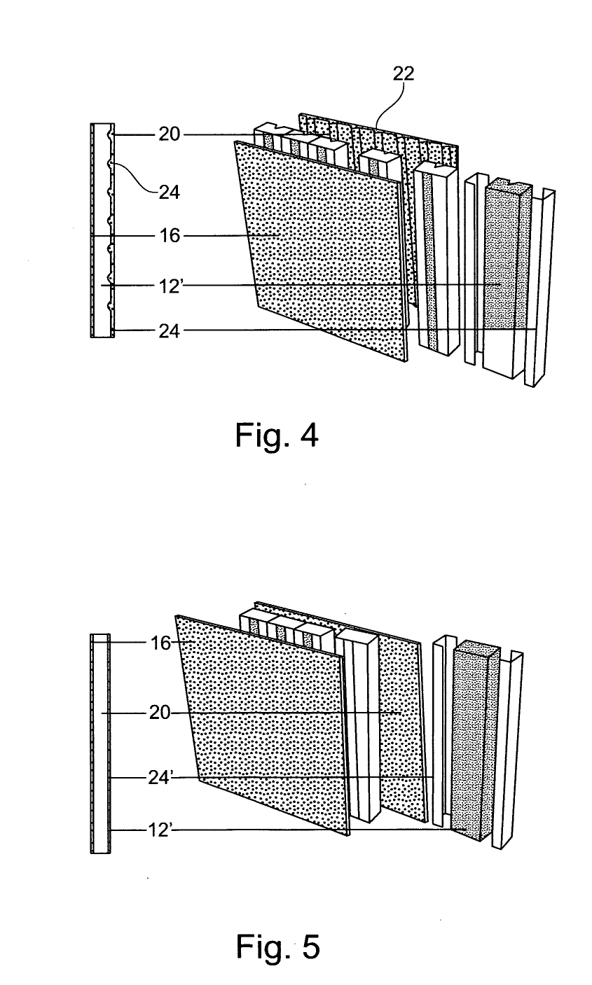

In a still further advantageous embodiment of the invention as illustrated in FIGS. 4 and 5 as is the case with the embodiments described above the front and rear side elements of 16, 20 are made from high strength concrete. The rear side element 20 is furthermore provided with ridges 22 as discussed above with reference to FIG. 2. In this embodiment the insulation 12 comprises a number of separate insulating pieces 12′. Each insulating element is along two side edges provided with casings 24 made from a woven or non-woven cloth material, for example the same cloth material as used in the embodiments discussed above.

By applying a suitable adhesive such as for example an epoxy resin based adhesive to the non-woven or woven cloth material a very rigid structure will be achieved across the panel, i.e. from the rear side panel 20 to the front side panel 16. In that the casings 24 are made from a cloth material impregnated with an epoxy resin in order to provide the necessary adhesion and rigidity a very rigid construction is achieved and at the same time a high insulating value is maintained due to the fact that the resin impregnated casings are very poor heat conductors. By furthermore providing the ridges 22 and 24 a very light, rigid and strong panel construction is achieved.

The embodiment illustrated in FIG. 5 corresponds to the embodiment in FIG. 4, except for the fact that the rear side element 20 is not provided with ridges and therefore will be somewhat lighter and not as strong as the embodiment of the invention depicted in FIG. 4.

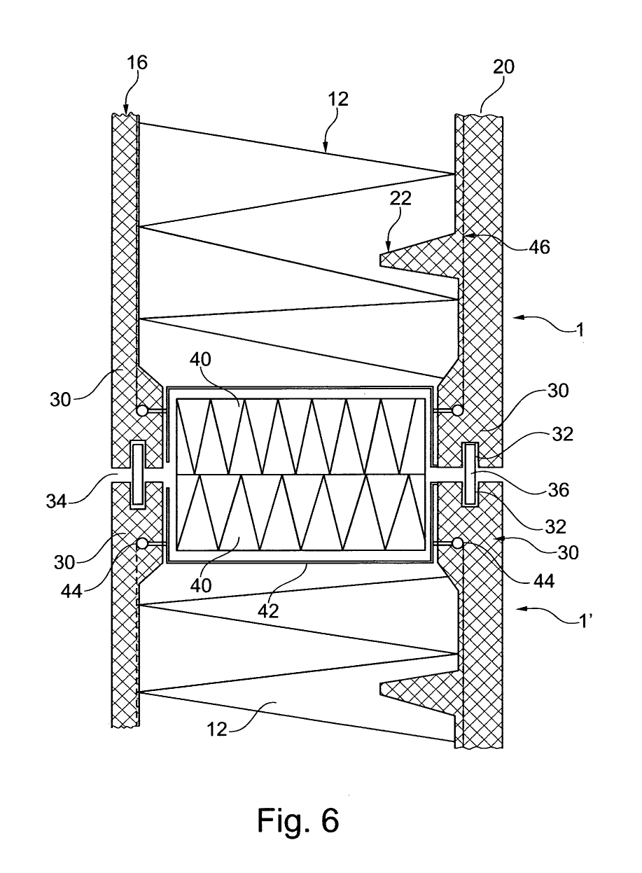

The FIG. 6 through 22 illustrate various details relating to connections between two adjacent constructional panels according to the invention as well as details relating to how the panels may be incorporated into a building.

One of the main objects of the present invention, as already discussed above is to provide very rigid, light and high insulating panels which may be used for a number of purposes. It is therefore important that the assembly details between adjacent panels may be carried out in a rational manner such that it is ensured that the high insulating properties of the constructional panel incorporated into a building system is maintained.

With reference to FIG. 6 is illustrated a connection between two adjacent panels 1, 1′ seen in a plain view. The constructional panels 1, 1′ comprises a front side element 16 as well as a rear side element 20 which is provided with ridges 22. Between the front side panel 16 and the rear side panel 20 is provided insulating material 12.

Each panel is furthermore provided with an enlarged concrete foot section 30. This enlarged foot section provides added strength along the edges of the panels where they are most fragile, and furthermore provides the opportunity to provide a groove 32 along at least one side edge of each element. As two panels 1, 1′ are arranged in the proper position as illustrated with reference to FIG. 6 a gap 34 will be present between the two panels 1, 1′. In order to avoid water, moisture, wind and other detrimental and undesirable matter to enter into the interior of the panel a resilient sealing member 36 may be arranged in the grooves 32 such that the gap 34 is closed by the resilient member 36. In other embodiments the resilient member 36 may in fact be two lip halves cast into the enlarged foot sections 30 of each element 1, 1′ such that when the elements 1, 1′ are installed in their proper position, for example as illustrated with reference to FIG. 6, the resilient members will abut each other and in this manner create a seal completely corresponding to the effect achieved by the resilient member 36 in FIG. 6.

In this embodiment the insulation 40 along a side edge of each panel 1, 1′ is a fire proof insulation material, for example rock wool. The side edge insulation 40 is arranged in a glass fibre reinforced or otherwise reinforced polymer insert 42 which is cast into the enlarged foot sections by anchor members 44. The insulating material 40 is lightly compressed during manufacture of the panel 1, 1′ such that as the concrete panel is removed from the casting mould the insulation 40 will expand such that it projects past the side edge concrete. In this manner when two panels according to the invention are placed in their proper relative position as illustrated with reference to FIG. 6 the side edge insulation parts 40 will be sufficiently expanded whereby they will come into contact and create a heat and fire insulating barrier between the two panels. In this manner the insulating material 12 does not need to be fireproof in that the panel due to the insulating materials in the side edges and the concrete front and side elements 16, 20 will provide the necessary fire protection.

In the embodiment illustrated with reference to FIG. 6 a glass fibre reinforcement netting 46 illustrated by dashed lines is furthermore embedded in the high strength concrete in order to provide an even better rigidity, ductility and strength of the constructional panel.

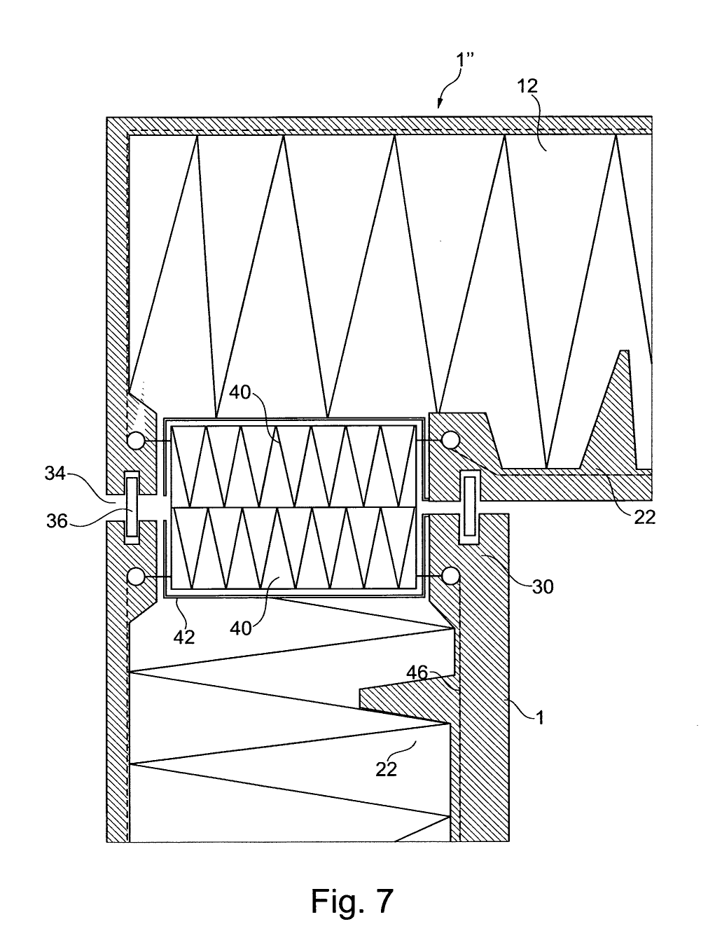

Turning to FIG. 7 a plane view of a corner construction is illustrated. As is evident from the corner construction the same properties relating to moisture barrier, moisture tightness of the gap 34 between two adjacent panels 1, 1″ is maintained.

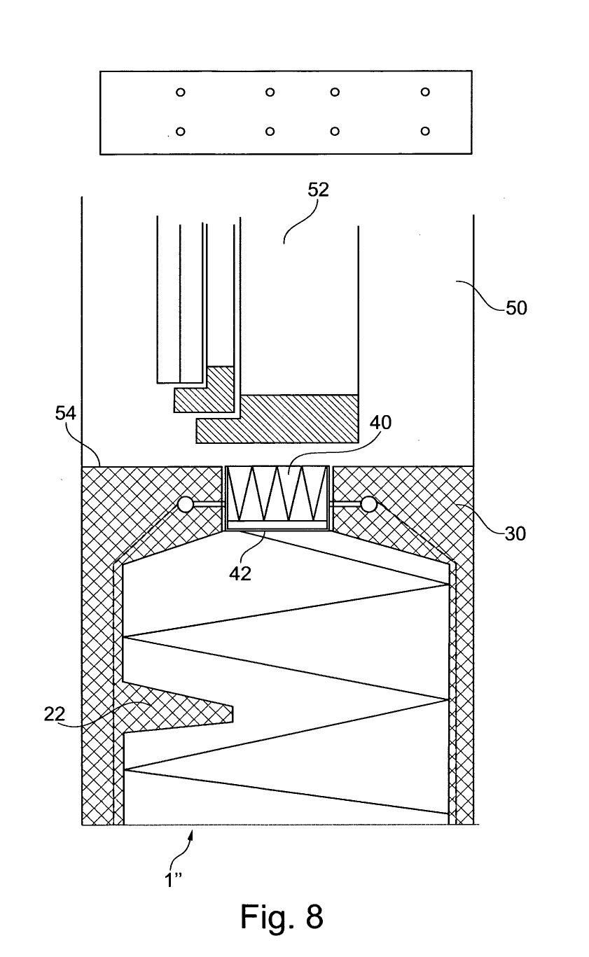

Turning to FIG. 8 a horizontal cross section through a panel 1″ is illustrated. In the panel 1″ is provided an opening 50 in which for the sake of illustration part of a window frame element 52 is schematically illustrated. The insulating section 40 in the side edge 54 is arranged such that the window frame 52 will be superposed the insulating section 40 such that only concrete surfaces 54 will be exposed. In some instances it might be advantageous to, in addition to the insulation section 40 to have sections embedded in the side edge where a screw connection may be provided between a window frame element 52 and the concrete panel 1″. In those circumstances part of the insulating material placed in the insulating section 40 may be of a type suitable to be used with a screw connection or means such as an embedded nut may be provided in the embedded member 42 such that a screw or bolt will pass through the window frame 52, the insulating material 40 and be fastened by engagement of a nut embedded in the member 42.

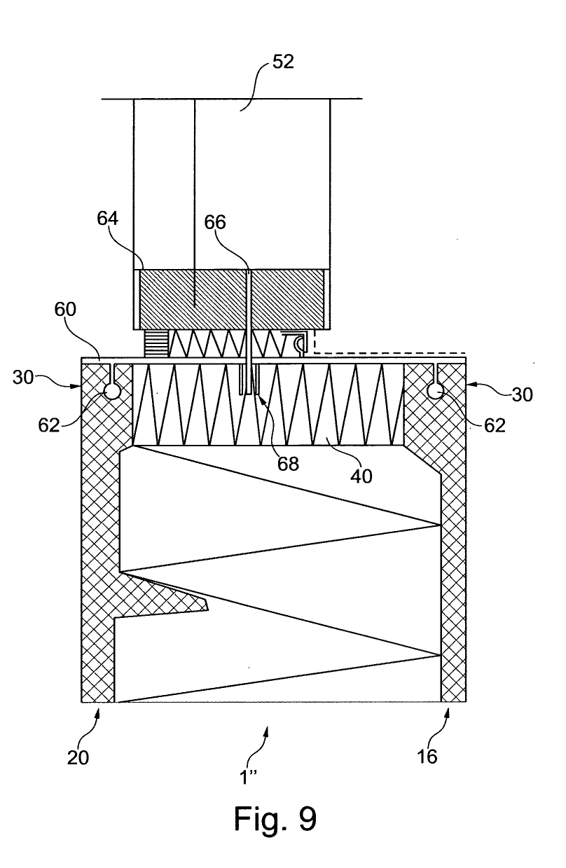

With reference to FIG. 9 a further embodiment is illustrated. In this embodiment a relatively rigid member 60 covers the entire side section of the concrete panel 1″. The rigid member 60 is embedded by means of anchors 62 in the enlarged foot sections 30 of the front side element 16 and the rear side element 20.

The rigid member 60 furthermore is provided with the means for easy attachment of a frame, for example a door frame or a window frame 52. Additional insulation 64 may be provided between the rigid member 60 and the window frame 52 in a known manner. In this embodiment the frame 52 is fastened to the rigid member by means of a bolt 66 engaging a knot 68 embedded in the rigid member 60. In this fashion the insulating section 40 retains all its advantageous properties and at the same time a prepared mounting bracket for the window frame 52 is provided.

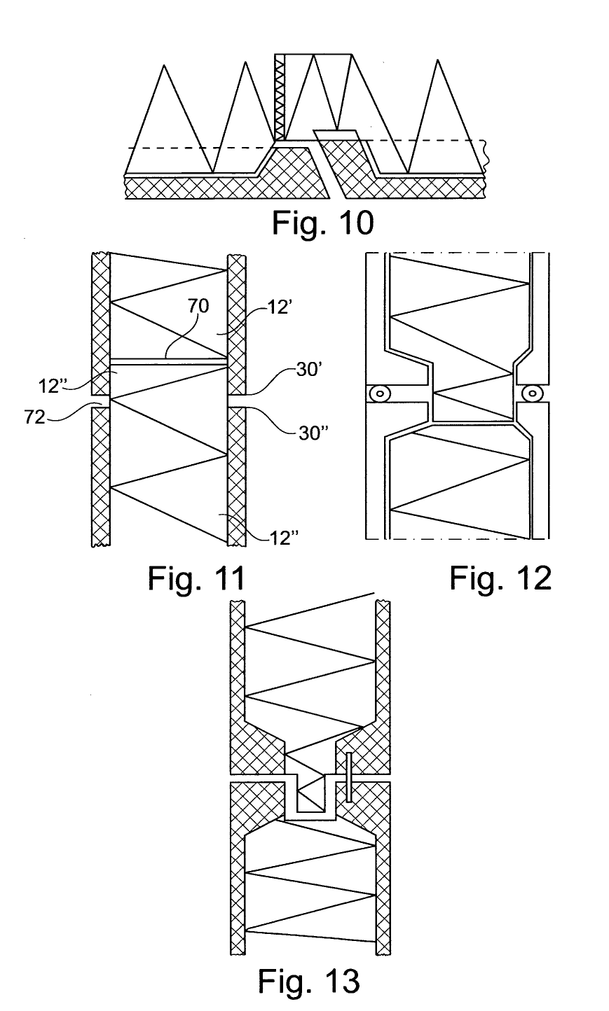

In FIG. 10-13 is illustrated various solutions on how to displace the connection between the insulation 12 of the concrete panel members in relation to the joints 70 between the front side element and rear side element. For example with reference to FIG. 11 this is done by terminating the insulation 12′ short of the concrete panel's footing 30′ such that a recess is provided. The adjacent panel is provided with an insulation 12″ which extends past the concrete enlarged footing section 30″ and fits into the recess provided in the adjacent panel. In this manner the joint 70 between the insulating bodies 12′, 12″ is displaced relative to the joint 72 between two adjacent concrete side elements.

In the FIGS. 10, 12 and 13 comparable solutions are suggested incorporating further features already discussed above.

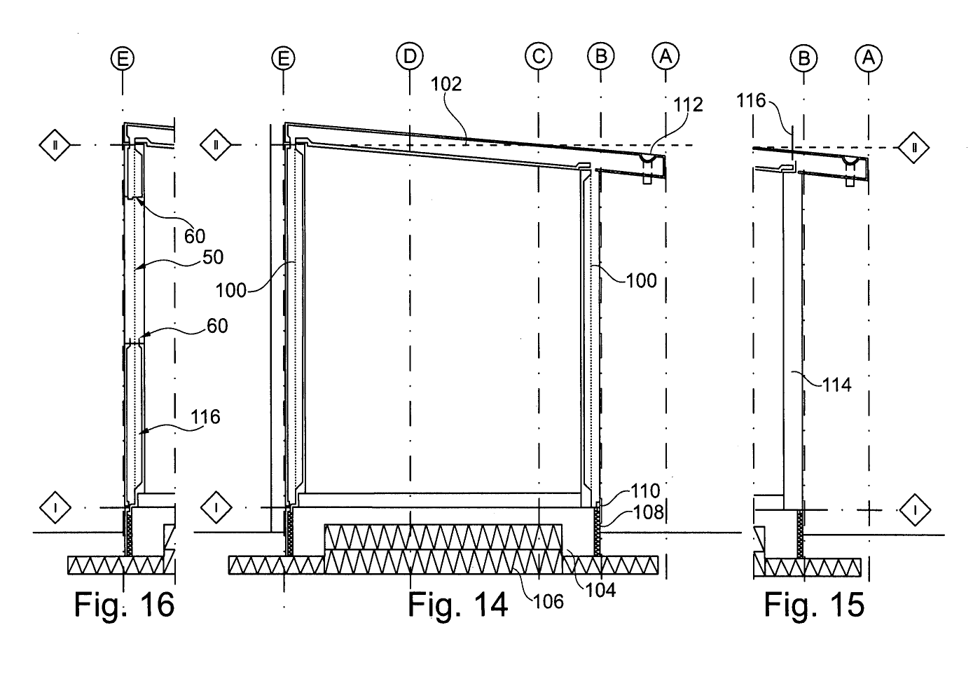

With reference to the FIG. 14-22 specifically detailed constructional drawings illustrating various manners of implementing the inventive constructional panel according to the invention with the inventive connection details as discussed above are illustrated.

In FIG. 14 a vertical cross section through a building incorporating wall elements 100 and a roof element 102 according to the invention is illustrated. Traditionally, the building is set on a foundation 104, for example cast in situ, which foundation is resting on an insulating layer 106. In order to protect the cast in situ concrete from the direct exposure to the soil and moisture, a high strength concrete panel 108 including insulation 110 has been provided as a cover member to the in situ cast foundation.

The roof element 102 is provided with an integrated gutter 112. Especially since the high strength concrete is very dense and water tight, it may be advantageous to provide the gutter as an integrated part of the panel, such that extra manual work on site may be avoided in this connection.

With reference to FIGS. 15 and 16 is illustrated in FIG. 15 a cross section where a window element 114 is inserted between a mounting bracket 116 fastened to the roof panel 102 and where the window panel 114 is fastened to the floor. In FIG. 16 is illustrated a panel with constructional details as already discussed above with reference to FIGS. 8 and 9, i.e. a panel 116 in which an opening 50 is provided such that a window frame construction may be inserted. Means in the shape of rigid members 60 are embedded in the concrete bordering the opening 50 as already discussed above with reference to FIG. 9.

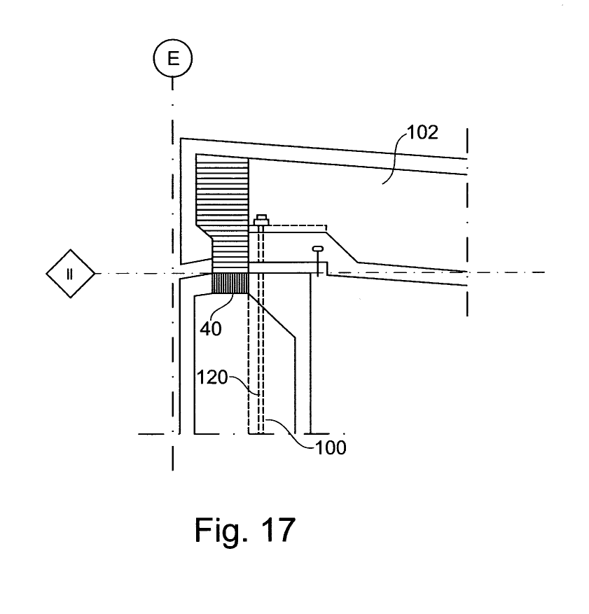

In FIG. 17 is illustrated a detail between the wall element 100 and the roof element 102 where it is evident that the insulating section is continued such that a continuous thermal barrier is provided in the concrete panels regardless of the constructional details. In order to provide resistance against the lift arising from a wind load a bolt 120 connecting the roof element 102 to the foundation structure 104 (see FIG. 14) is provided.

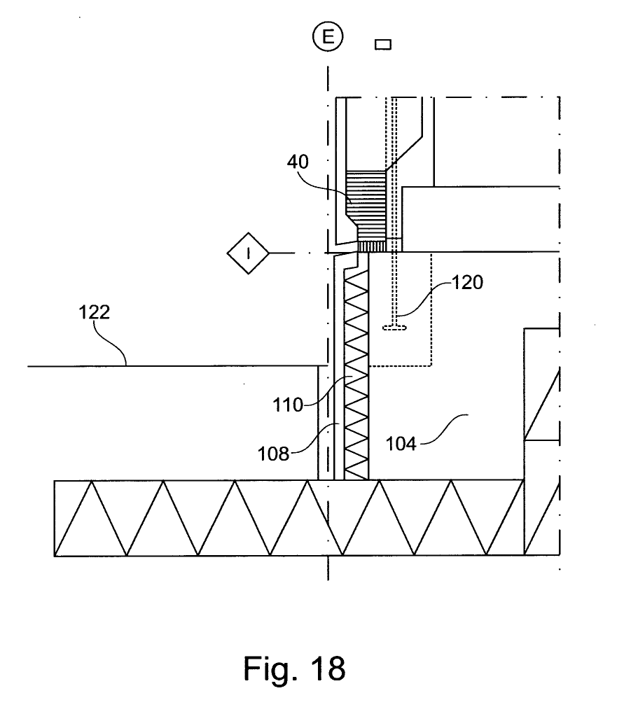

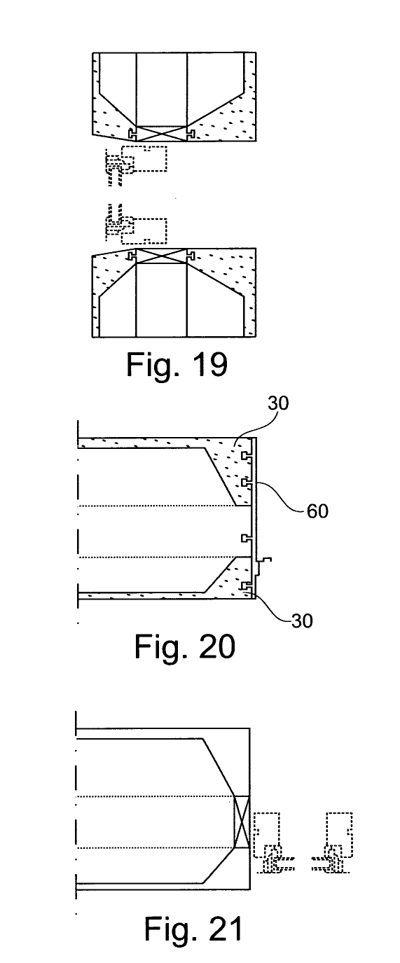

In FIG. 18 the details regarding how the foundation 104 is provided with an insulating layer 110 covered by a high strength concrete panel 108 in the zone adjacent the surface of the soil 122 are illustrated. The high strength concrete panel 108 is attached to the insulation with adhesive, for example an epoxy based resin, as is the insulating panel 110 attached to the in situ cast concrete foundation 104. The bolt 120 described with reference to the roof construction (see FIG. 17) is also embedded in the in situ cast concrete 104 such that the forces from the roof section may be distributed to the foundation. The insulating section 40 is, due to its proximity to the soil extended in that this part of the construction may be exposed to extended levels of moisture over extended periods of time. FIGS. 19, 20 and 21 illustrate some of the same details as was already discussed above with reference to FIGS. 8 and 9.

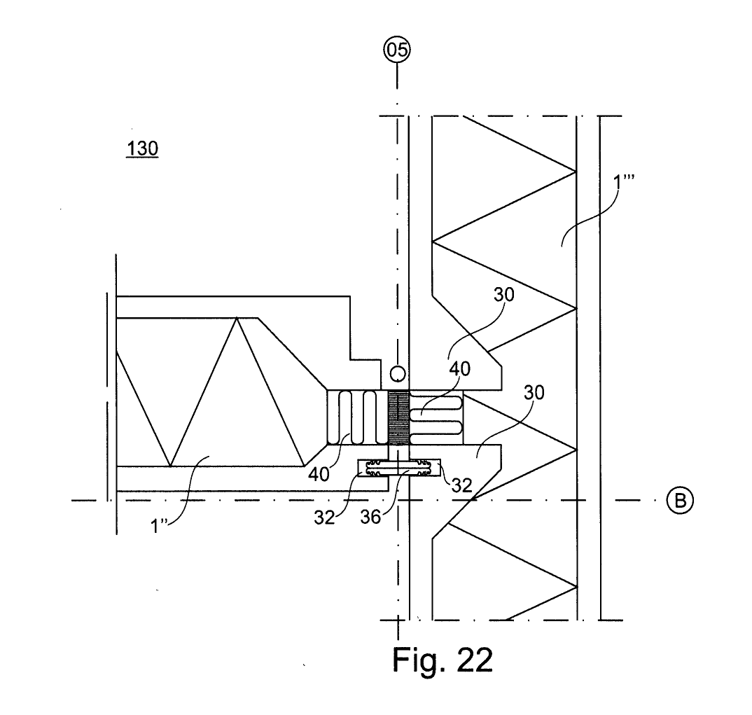

In FIG. 22 is illustrated a special connection between two elements which could be comparable to a roof connection. In this instance it is a horizontal cross section through two wall panels arranged at an angle. The inside of the building is indicated by reference number 130 and the other surfaces of the concrete panels are therefore exposed to the exterior. Grooves 32 and a resilient profile 36 as discussed with reference to FIGS. 6 and 7 are provided in order to provide a water, debris and moisture barrier.

The concrete panel 1′″ is provided with large footing sections 30 positioned where the adjacent wall panel 1″ is designed to engage. The enlarged foot sections therefore serve to provide concrete thickness in order to accommodate the grooves and to provide extra strength such that the insulating sections 40 and the forces arising in a corner may be accommodated.

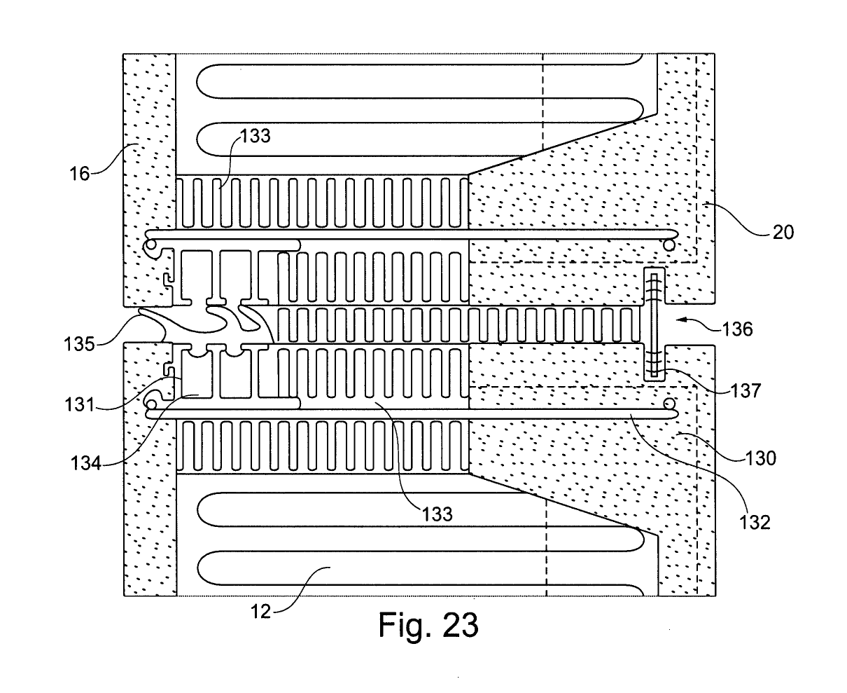

In FIG. 23 is schematically illustrated the concepts of assembly between two identical panels according to the invention. The fig. illustrates a horizontal section through adjacent ends of adjacent panels.

Each panel 1 has a front side element 16 and a rear side element 20, and insulation 12 interposed between the front and rear side elements. The rear side element is provided with an enlarged foot section 130 (i.e. a vertical beam along a side edge—in use). The front side element has a cast in profile 131, typically made from plastics, and furthermore a connection member 132 connecting and maintaining the front respectively rear side panels at a desired mutual distance. The connection member 130 may be a plurality of strips, strings or the like arranged at intervals along the side edge of the panel. The connection member is made from a stable mechanically strong and relatively stiff material, which has poor heat conduction properties and remains stable with respect to heat, in particular fire.

Flexible and fire resistant insulation 133 is arranged along the edge of the sandwich panel, between the front and rear side panels 16,20.

The profile 131 is provided with one or more cavities, where access to each cavity is possible from the edge of the panel. Each cavity is shaped such that it is suitable to receive a closing profile 135, which is firmly installed in the cavity. The closing profile has a number of lips extending from the base of the profile, such that the lips will be projecting away from the profile 131. When to elements are arranged next to each other in a façade, as illustrated in FIG. 23, the lips will be deformed by the profile 131 of the adjacent element. Alternatively (not illustrated) a further closing profile 135 may be arranged in the adjacent element such that the lips of the two closing profiles 135 creates a wind, moisture and pressure resistant joint, which in addition is also flexible.

The construction close to and around the edges of the panels is such that the inventive concrete sandwich elements, without further ado are compatible to be built together with so-called “curtain wall façade elements”. These elements are use on a large scale for facades, and the elements are typically made from aluminium and glass. This compatibility opens up new possibilities for façade constructions which has not been possible until now, with traditional heavy concrete elements.

In order to provide an inner moisture barrier, a flexible sealing profile 136 is provided. In the rear side panel, grooves 137 are provided, such that the sealing profile 136 may be inserted in facing grooves, and by means of fins be retained in grooves on both sides of the gab between two adjacent elements, as illustrated.

With this construction it is achieved that the joints between adjacent panels are efficiently sealed against moisture, wind and debris, and at the same time the joints are highly flexible allowing the concrete elements to move, for example due to thermal expansion and the like. The manner of creating the joints also reduces the risk of error, in that most part of the joints may be performed under factory conditions and not on site. On site, all which is necessary is to assure that the sealing profile 136 is correctly arranged in the grooves 137.

The term high strength concrete shall be understood as meaning a concrete like mixture, that is to say a material containing cement, sand, aggregate and water and optionally additives, which will harden and exhibit very high compressive strengths, i.e. more than 100 MPa and preferably more than 250 MPa. The properties of the materials per se are not within the scope of the present invention, but for the sake of completeness materials fulfilling the requirements to strength, durability and density/compactness may be obtained from Contec ApS, Århus Denmark.

Although the invention has been described with reference to various connection details, it will be clear to a skilled person that a number of different connection details may be contemplated within the scope of protection, and with special regard to the use of high strength concrete which provides unique possibilities due to the very shallow constructions which are possible due to the very high strength of the concrete material. Comparable properties as disclosed above in the light panels will only be found in concrete panels that are very heavy and therefore very expensive to transport and install. Therefore the scope of protection shall only be limited by the appended claims.

1. Constructional panel having a front side suitable to be exposed to outside weather conditions, comprising a front side element, a rear side element and an insulating material arranged between said front and rear side elements, where the front side element is made from a high strength concrete, having a thickness between 5 and 50 mm, and where the insulating material is adhered to the rear side of said front and rear side elements.

2. Constructional panel according to claim 1, wherein the front and/or rear side elements are made from a high strength concrete, having a compressive strength of at least 100 MPa, preferably more than 250 Mpa and most preferred more than 400 MPa and where the concrete material thickness is between 5 mm to 30 mm, more preferred 8 mm to 20 mm, and most preferred 10 mm to 15 mm.

3. Constructional panel according to claim 2, wherein fibres are comprised in the concrete material, where the fibre content is between 1% to 10% by weight of dry material weight, more preferred 2% to 5% by weight of dry material, and that the fibres are selected among fibres made from carbon, glass, polypropylene, polyethylene, steel and in particular stainless steel, ceramics.

4. Constructional panel according to claim 1, wherein the insulating material is a foam, and in particular a polystyrene or polyurethane foam, or an expanded material, in particular a rock/mineral wool or a glass wool, where the thickness of the insulating material between the front and rear side elements is 100 mm to 350 mm more preferred 150 mm to 275 mm, and most preferred 175 mm to 250 mm.

5. Constructional panel according to claim 4, wherein reinforcement is integrated in the insulating material, where said reinforcement may be arranged between the front and rear side elements and/or arranged parallel to said front side on the surface of or inside the insulating material.

6. Constructional panel according to claim 4, where the reinforcement is a woven fibre textile or bundle of fibres, which textile or bundle of fibres is arranged partly parallel to a side element and across the thickness of said insulation, and where the reinforcement optionally is adhered to the front and/or rear side elements or is partly embedded in the concrete material.

7. Constructional panel according to claim 6, where the reinforcement is further substantially saturated by a polyester or epoxy based resin.

8. Constructional panel according to claim 1, where on the side of the front side element and/or the rear side element being in contact with the insulation, concrete protrusions are arranged spanning a certain distance, and where concrete reinforcement is provided embedded in said protrusions, and that accommodating grooves for accommodating the protrusions are provided in the insulation.

9. Constructional panel according to claim 1, wherein the panels are manufactured in standard sizes, preferably 900 mm wide, 2000 mm long and thicknesses between 120 mm to 450 mm.

10. Constructional panel according to claim 1, wherein the panel is limited by side edges between said front side element and said rear side element, where the side edges comprises an insulating section, such that along the side edges the front side elements and rear side elements are not thermally connected.

11. Constructional panel according to claim 10, wherein a groove is provided in said side edges in which groove a resilient profile is retained.

12. Constructional panel according to claim 10, wherein a part of a frame for a door, window or the like is cast into the concrete of the front and rear side elements, spanning the insulating section, where said part of a frame is provided with means for engaging and snapping on the rest of the frame.

13. Constructional panel according to claim 10, wherein the insulating sections along two side edges projects past the concrete panels, and that the insulating sections along two other sides are recessed relative to the concrete panels.

14. Constructional panel according to claim 1, wherein the upper and lower edge of the rear resp. front side elements has an enlarged concrete foot section.

15. Method for manufacturing constructional panels according to claim 1, wherein a front side element is placed with its face down, insulating material is placed on top of the front side element, and the rear side element is placed on top of the insulation, where the insulation is pre-made with reinforcement, and that prior to placing the reinforcement on the front side element, an adhesive, for example an epoxy resin is arranged on the front side element, and after having placed the insulation material, the free surface of the insulation is treated with an adhesive, for example an epoxy based resin, after which the rear side panel is placed on the insulation material.

16. Method for manufacturing constructional panels according to claim 15, where the front side panel is extruded, and as the panel leaves the extruder, the insulating material and reinforcement is partly embedded in the upper surface layer of the still wet concrete, where after the rear side element is placed on the insulating material optionally after having arranged an adhesive on said insulating material, or said rear side element is extruded onto the insulating material and partly worked into the surface of the insulating material and/or reinforcement material.
